(19) United States
(12) Patent Application Publication
(10) Pub. No.: US 2012/0096120 A1
(43) Pub. Date: Apr. 19, 2012

(54) INTERNET HOME AUTOMATION SYSTEM

(75) Inventors: Philippe Couillabin, Moussaux Sur Seine (FR); Nicolas Oudard, La Garenne Colombes (FR); Philippe Dailland, Paris (FR)

(73) Assignee: HOME TECHNOLOGY, Saint-Benin-d'Azy (FR)

(21) Appl. No.: 13/380,176

(22) PCT Filed: Jun. 18, 2010
(86) PCT No.: PCT/FR2010/051223

§ 371 Date: Dec. 22, 2011

(30) Foreign Application Priority Data
Jun. 25, 2009 (FR) 0954353

(51) Int. Cl. G06F 15/16

(52) U.S. Cl. 709/218

(57) ABSTRACT

A home automation housing includes: a first interface for connecting the home automation housing to the Internet network; a second interface for at least one home device for exchanging information between the home automation housing and the at least one home device; the first interface and the second interface being capable of exchanging information by way of a data transfer link. The home automation housing of the invention is further configured to enable the operation of the home devices using a remote server via the connection to the Internet network. Also described is a home automation system, including: a home automation housing; and a remote server on which a remote user interface, accessible by the user of the home automation housing via a communication element and the Internet network, is installed.

The present invention relates to a home automation box and system, i.e. allowing a user to exchange information and commands remotely with household appliances installed on a site, using the Internet. This applies to all types of premises, whether residential or industrial, provided that they are equipped with a power source and an active Internet connection.

Home automation systems using the Internet are already known. Some of those systems use a home automation box connected to an “internet box” network connection box, which are increasingly common. In the context of a subscription with an Internet Service Provider (ISP), these internet boxes provide three services: a fast Internet connection (ADSL), telephone and television.

However, these systems have drawbacks:

the user interface of the home automation box is complex,

it is difficult to upgrade the system, for example to add, modify or remove a household appliance.

As a result, they are expensive and complicated to implement.

It is one object of the present invention to provide an inexpensive home automation box that is easy to use, easily adaptable to a wide variety of household appliances, compatible with distribution in stores selling to the general public. To that end, it proposes a home automation box comprising:

a first interface means for connecting said home automation box to the Internet,

a second interface means with at least one household appliance to make it possible to exchange information between said home automation box and said at least one household appliance,

the first interface means and the second interface means being able to exchange information owing to a data transfer connection.

The home automation box can also be configured to allow the exploitation of at least one household appliance using a remote server, through the Internet connection channel.

This arrangement has the advantage of offloading a certain number of functions regarding the management of the household appliances to the remote server, and therefore of simplifying and reducing the cost of the home automation box. The remote implementation of household appliances may involve exchanging information between the home automation box and the remote server, for example concerning the configuration of the user's facility or the user's commands.

Access to this remote server may be part of a home automation service provided to multiple users at the same time as the home automation box, for example in the form of a subscription.

Advantageously, the first interface means can include an IP processor means and the second interface means can include at least one real-time processor means.

The processor means may be:

either distinct processors and the data transfer link may be a serial link between the two processors, or

made up of a single processor.

The IP processor manages communications with the remote server. The real-time processor centralizes the information coming from the household appliances, exploits it in different usage contexts and executes the commands coming from the IP processor or client scenarios onboard the processor.

Advantageously, the home automation box can also include a local user interface installed in said IP processor, to exploit at least one household appliance via a local dialogue means and an Internet connection.

The local user interface is for example a limited web interface making it possible to steer the appliances locally. Active on a private network, no authentication is necessary, except for the critical functions, such as disarming the alarm. In this way, the user can continue to use the box even if the remote server is unavailable. The local dialogue means can for example consist of a television remote control and television decoder, a WiFi telephone or a computer connected to the Internet.

Advantageously, the box can include at least one dialogue means incorporated into the home automation box so as to allow the user to dialogue with said local user interface.

In this way, the user can continue to use the box even in the event no internet connection is available. The dialogue means can for example be a touch screen, a keyboard, a screen, etc.

Advantageously, the Internet connection can use an ADSL line and a connection means such as a traditional ADSL box of the “triple play” type, an ADSL router or a CPL ADSL adapter.

Furthermore, the first interface means can include a SIM card and the Internet connection can use a mobile telephone protocol, in particular of the GSM/GPRS type.

Advantageously, the second interface means can include radio communication means and/or a carrier current interface, CPL.

The second interface means must have a dialogue means enabling it to adapt to the different communication standards used by household appliance suppliers, for example standard X10™ or a HF radio link, for example 433 MHz or 868 MHz.

Advantageously, the home automation box can also include at least one communication module specific to a household appliance supplier, interfaced with the second interface means.

The invention also relates to a home automation system including:

a home automation box according to the invention,

and a remote server on which a remote user interface lives accessible to the user of said home automation box via a dialogue means and the Internet and allowing the user to implement the household appliances connected to the home automation box.

The remote server has a user interface, for example in the form of a web browser accessible by Internet via remote dialogue means, for example a telephone equipped with the GPRS capacity or a computer accessing the Internet away from the residence.

It involves an interface procuring the broadest possible functionalities for the user, in particular that remote interface may by itself allow the user to configure the system according to the household appliances that are connected to the home automation box.

Advantageously, an administrator interface can live on the remote server.

This user interface can be used by the service provider to manage the fleet of boxes in a coordinated manner, for example to deliver software updates, fix bugs, etc.

Advantageously, the remote server implements a secured protocol for exchanging information with the home automation box and for updates.

This may for example involve an AES or https encrypted http protocol. This feature is crucial inasmuch as the household appliances managed by the box may include casements (shutters) or alarm units.

Several embodiments of the invention are described below, as non-limiting examples, in reference to the appended drawings, in which:

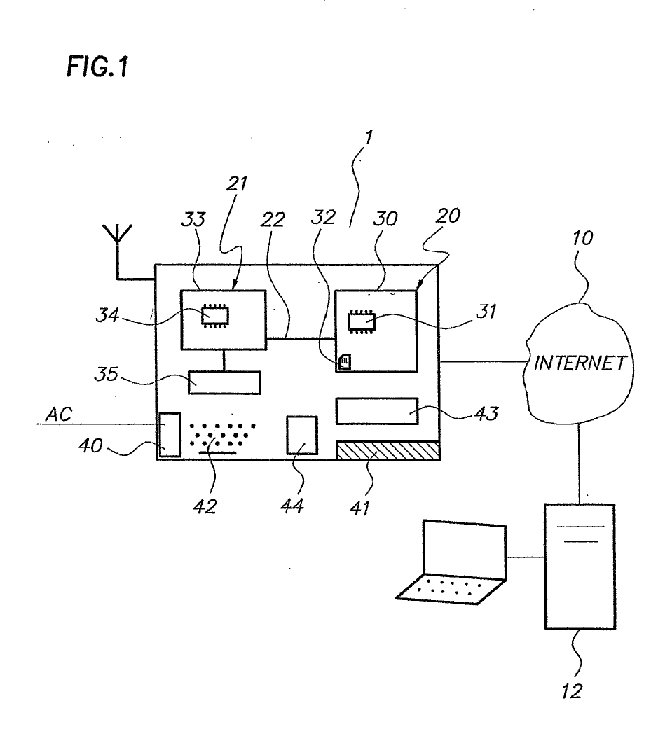

FIG. 1 shows a schematic diagram of the home automation box according to the invention,

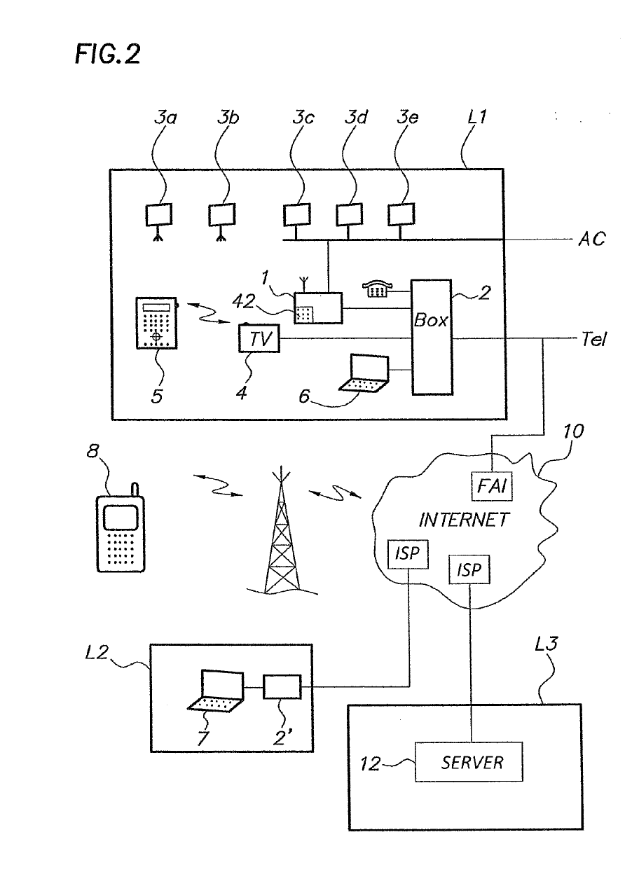

FIG. 2 shows a schematic diagram of the home automation system according to the invention.

The home automation box 1 includes:

a first interface means 20 comprising a first electronic board 30 bearing an IP processor 31; this board is also connected to a SIM card 32 for Internet communications through an existing mobile telephone network (for example GPRS, EDGE, UMTS, HSPDA (3.5G)) or a future one (HSUPA (3.75G), OFDM, LTE (4G));

a second interface means 21, in the form of a second electronic board 33 that bears a real-time processor 34. This electronic board 33 also includes means for connecting to household appliances, in particular a radio transceiver and an interface at standard X10™.

The two boards 30 and 33 are connected by a serial data link 22.

The IP processor 31 handles communications with a remote server 12 via Internet through different supports (ADSL, GPRS, etc.). Its role is to transfer the orders coming from the server 12 to the real-time processor 34 by extracting data from the IP frame and converting the events generated by the processor 34 into an IP frame toward the server 12.

The last state of the entire configuration as well as the current version of the software for the processor 34 are also saved.

For communication, the IP processor 31 uses as open a communication protocol as possible while freeing itself from the nature of the appliances, which leaves the possibility of incorporating other peripherals.

The box illustrated in FIG. 1 is corrected directly to the Internet by an ADSL link.

The processor 34 manages the exchanges with the sensors/actuators of the household appliances 3a to 3e of the residence while taking the client scenarios into account on the one hand, and on the other hand the communication with the IP processor 31 for dialogue with the outside world. This processor 34 is interfaced by a communication protocol serially connected with one or more proprietary communication module(s) 35 of a household appliance supplier to be compatible with the associated product line.

The box 1 also includes:

a power supply 40 and a back-up battery 41 so as not to lose all of its data in the event of an interruption in the sector,

dialogue means incorporated into the box, a keyboard 42, a screen 43 and a touch screen 44, which allow the user, via a local interface, to interact with the box 1 in order to control it in case of Internet downtime.

In another embodiment not shown, the processors 31 and 34 are united in a single processor.

The home automation system illustrated by FIG. 2 includes, positioned in a site L1, for example a user's residence, a home automation box 1 connected, on the one hand, to an Internet connection box 2 and, on the other hand, to household appliances 3a to 3e.

The Internet connection box 2 provides, via an Internet Service Provider (ISP), a “triple play” service, i.e. telephone, an ADSL broadband Internet connection and television programs via an Internet connection 10. It provides a local network, for example using the Ethernet protocol, to connect appliances such as a computer 6. The household appliances 3a to 3e communicate with the home automation box 1 by radio for the appliances 3a and 3b or by carrier currents, for example at standard X10™, for appliances 3c to 3e.

The household appliances 3a to 3e can for example be actuators (rolling slat blind motors, boiler pumps, etc.), lighting means, a monitoring—control means (alarm unit, heating regulation, etc.), cameras.

Also connected to the Internet connection box 2 are:

a television decoder 4, the user interface of which is a remote control 5,

a computer 6.

The user can send commands to the household appliances 3a to 3e in several ways:

locally, using the television remote control 5 or the computer 6 connected to the connection box 2,

using a remote computer 7 situated in a location L2 and connected to the Internet 10 via a MODEM or a box 2′ and an ISP,

using a mobile telephone 8 at the GPRS standard, i.e. capable of exchanging content via the Internet 10, locally or remotely.

The home automation system also includes a remote server 12, situated in a location L3, connected to the Internet 10 via an ISP, this server being shared by all users of a same home automation service. The server 12 constitutes the preferred access point to the service irrespective of the dialogue means used by the user. Installed in the server 12 is a software application whereof the primary functions are:

connection by Internet with the boxes subscribing to the home automation service,

exchanges of messages (authenticated) with the home automation boxes,

access to the data of the boxes,

reception of events coming from household appliances connected to each box,

automatic archiving of data changes concerning the appliances,

appliance update management,

management of the installed fleet of boxes,

planning and performance of software update campaigns.

The user accesses the service via a remote interface also installed in the server 12. This interface provides the user with functions useful in managing his subscription to the home automation service (billing, contact, online help, etc.) and functions for controlling his household appliances (in particular the configuration), via an interface adapted to those appliances. It is accessible in whole or in part using a password.

The server 12 dialogues with the home automation boxes 1 whether the IP addresses are static or dynamic and uses secured protocols, so as to prevent an ill-intentioned person from capturing the user's password and commands, since the household appliances can include an alarm unit or opening commands.

For example, the user may remotely command an increase in the temperature in the location L1 to prepare for his return after a lengthy absence.

In the other communication direction, the user may be informed of the temperature reached, an alarm or the entry of a person into the premises identified by an electronic key or a personal access code, for example a child's return from school. This information can for example be sent by text message, email or voice alert, the sending of information being configurable using the user interface.

1. A home automation box (1) comprising:
a first interface means (20) for connecting said home automation box (1) to the Internet (10),
a second interface means (21) with at least one household appliance (3a, 3b, 3c, 3d, 3e) to make it possible to exchange information between said home automation box (1) and said at least one household appliance,
the first interface means (20) and the second interface means (21) being able to exchange information owing to a data transfer connection (22)
characterized in that it is also configured to allow the exploitation of at least one household appliance (3a, 3b, 3c, 3d, 3e) using a remote server (12), through the Internet connection channel (10).

2. The home automation box according to claim 1, characterized in that:
the first interface means (20) includes an IP processor means (31),
the second interface means (21) includes at least one real-time processor means (34).

3. The home automation box according to claim 2, characterized in that said IP (31) and real-time (34) processor means are distinct processors and in that the data transfer link (22) is a serial link between the two processors

4. The home automation box according to claim 2, characterized in that said IP (31) and real-time (34) processor means are made up of a single processor.

5. The home automation box according to claim 1, characterized in that it also includes a local user interface installed in said IP processor means (31), to exploit at least one household appliance (3a, 3b, 3c, 3d, 3e) via a local dialogue means (4, 5, 6) and an Internet connection.

6. The home automation box according to claim 5, characterized in that it includes at least one dialogue means (42, 43, 44) incorporated into the home automation box (1) so as to allow the user to dialogue with said local user interface.

7. The home automation box according to claim 1, characterized in that the Internet connection (10) uses an ADSL line and a connection means chosen from the following list:
an ADSL box,
an ADSL router,
a CPL ADSL adapter.

8. The home automation box according to claim 1, characterized in that the first interface means (20) also includes a SIM card (32) and in that the Internet connection (10) can use a mobile telephone protocol, in particular of the GSM/GPRS type.

9. The home automation box according to claim 1, characterized in that said second interface means (21) includes radio communication means and/or a carrier current interface, CPL.

10. The home automation box according to claim 1, characterized in that it also includes at least one communication module (35) specific to a household appliance supplier, interfaced with the second interface means (21).

11. A home automation system, including:
a home automation box (1) according to claim 1,
and a remote server (12) on which a remote user interface lives accessible to the user of said home automation box (1) via a dialogue means (4, 5, 6, 7, 8) and the Internet (10) and allowing the user to implement the household appliances connected to said home automation box (1).

12. The home automation system according to claim 11, characterized in that only said remote interface allows the user to configure the system according to the household appliances (3a, 3b, 3c, 3d, 3e) that are connected to said home automation box (1).

13. The home automation system according to claim 11, characterized in that an administrator interface lives on said remote server (12).

14. The home automation system according to claim 11, characterized in that said remote server (12) implements a secured protocol for exchanging information with the home automation box (1).

15. The home automation box according to claim 3, characterized in that it also includes a local user interface installed in said IP processor means (31), to exploit at least one household appliance (3a, 3b, 3c, 3d, 3e) via a local dialogue means (4, 5, 6) and an Internet connection.

16. The home automation box according to claim 4, characterized in that it also includes a local user interface installed in said IP processor means (31), to exploit at least one household appliance (3a, 3b, 3c, 3d, 3e) via a local dialogue means (4, 5, 6) and an Internet connection.

17. The home automation box according to claim 2, characterized in that the Internet connection (10) uses an ADSL line and a connection means chosen from the following list:
an ADSL box,
an ADSL router,
a CPL ADSL adapter.

18. The home automation box according to claim 3, characterized in that the Internet connection (10) uses an ADSL line and a connection means chosen from the following list:
an ADSL box,
an ADSL router,
a CPL ADSL adapter.

19. The home automation box according to claim 4, characterized in that the Internet connection (10) uses an ADSL line and a connection means chosen from the following list:
an ADSL box,
an ADSL router,
a CPL ADSL adapter.

20. The home automation box according to claim 5, characterized in that the Internet connection (10) uses an ADSL line and a connection means chosen from the following list:
an ADSL box,
an ADSL router,
a CPL ADSL adapter.
